(19) United States
(12) Patent Application Publication
(10) Pub. No.: US 2024/0062277 A1
(43) Pub. Date: Feb. 22, 2024

(54) GENERATING PERSONALIZED PHOTOBOOKS WITH VARYING DEGREES OF PERSONALIZATION AT DIFFERENT LEVELS OF GRANULARITY

(71) Applicants: Mudita Singhal, Santa Clara, CA (US); Anuj Ramesh Shah, Santa Clara, CA (US)

(72) Inventors: Mudita Singhal, Santa Clara, CA (US); Anuj Ramesh Shah, Santa Clara, CA (US)

(21) Appl. No.: 18/235,734

(22) Filed: Aug. 18, 2023

Related U.S. Application Data
(60) Provisional application No. 63/371,874, filed on Aug. 19, 2022.

(51) Int. Cl. G06Q 30/0601

(52) U.S. Cl. CPC G06Q 30/0643; G06Q 30/0629

(57) ABSTRACT

In one embodiment, a computer-implemented method for generating personalized photobooks for multiple entities with varying degrees of personalization at different levels of granularity is disclosed. The method includes generating a base template based on a content corpus. The base template may be transformed into a first dynamic template. Using at least the first dynamic template, the first personalized photobook may be generated for a first entity at a first level of granularity. The first dynamic template may be transformed into a second dynamic template. Using at least the first personalized photobook generated for the first entity at the first level of granularity and the second dynamic template, a second personalized photobook may be generated for a second entity at a second level of granularity. The second personalized photobook at the second level may be relatively more personalized than the first personalized photobook at the first level.

### PRIORITY

This application claims the benefit, under 35 U.S.C. § 119(e), of U.S. Provisional Patent Application No. 63/371,874, filed 19 Aug. 2022, which is incorporated herein by reference.

### TECHNICAL FIELD

This disclosure generally relates to personalized photobooks. In particular, the disclosure relates to generating personalized photobooks for multiple entities with varying degrees of personalization at different levels of granularity.

### BACKGROUND

With a digital camera equipped in portable electronic devices (e.g., mobile phones), the number of photos and videos taken at events has increased multifold. These photos, videos, and associated texts may be used to generate one or more photobooks, such as, for example, school yearbooks. A photobook is a digital or printed magazine/book showing content of an individual (e.g., student, child, or kid) or a group of individuals (e.g., team or sub-teams) during a period of time.

One example of such a photobook is a school yearbook. A person wishing to assemble such a photobook or other compilation of content for a team may face a daunting task of not only selecting which photos to go in the compilation to adequately and fairly represent all members in the team (e.g., a school), but also how to best arrange these photos and other information within the compilation. Secondly, with generating just a single yearbook or common yearbooks for the entire school, there are frequent complaints received from recipients (e.g., families of students) of such yearbooks stating that only a limited number of the photos in the school yearbook are of their children in spite of having lots of photos in the corpus that may be curated from multiple sources. These sources may include, for example, school event photographers, class photographers including teachers and families. The recipients of these yearbooks naturally desire to have the most interesting photos and other content, from their standpoint, in the photobook given to them.

The above-discussed problems can be circumvented with personalized yearbooks where each entity (e.g., a school, a grade, a classroom, a club, a student etc.) can have their own version of the yearbook. However, manually creating or reviewing multiple versions of a yearbook is a daunting task since even creating one yearbook takes the user (e.g., a designer) hours if not days of sorting through the content corpus, correctly ordering or categorizing them, rating them for use in the designer software, and including them in the photobook-designer application. The problem of photo selection and arrangement is exacerbated in the use case of personalized yearbooks in which the same content corpus that was used to generate a single yearbook is used to create multiple yearbooks for different teams or entities, such as, for example, a first yearbook corresponding to a particular school, a second yearbook corresponding to a class or grade, a third yearbook corresponding to a club or group of individuals, and a fourth yearbook corresponding to an individual. Doing this multiple times, once for each unique entity in the corpus manually is non-scalable and also inefficient.

### SUMMARY OF PARTICULAR EMBODIMENTS

The invention discussed herein presents methods and system for generating personalized photobooks for multiple entities with varying degrees of personalization at different levels of granularity, from a content corpus. In one example, the aspects described in the present disclosure facilitate in creating, reviewing, and ordering of personalized photobooks (e.g., yearbooks) that lead to, for example, but not limited to, minimizing creation time, minimizing review time, and error rate which is otherwise a time-consuming and costly process for multiple personalized photobooks. This may further help to improve the overall quality and productivity of photobook deliverables for the photobook industry, leading to better customer satisfaction levels for photobook organizations.

In particular embodiments, the photobooks may be iteratively personalized by at least (1) transforming a previous template from which a previous photobook was generated at a previous level of granularity into a dynamic template (e.g., unique or different template at particular level of granularity) for an entity at current level of granularity and (2) using the transformed template (e.g., dynamic template derived from previous template) to generate a personalized photobook for the entity at the current level of granularity. Using dynamic templates allows a user to better achieve coverage and comprehensiveness of the individuals' corpus of content, and scalable creation, reviewing and editing of the plurality of photobooks generated. In some embodiments, in addition to using the dynamic template, the personalized photobook for the entity at the current level of granularity may be generated using a pattern library of personalization patterns, content characteristics associated with the entity, and previous photobook(s) that have been generated. This may help to maintain a thematic similarity (e.g., similar theme, background, design elements, stickers, etc.) across all the personalized photobooks generated at different levels of granularity. The system and the method discussed herein continuously learns personalization patterns based on content characteristics and user activity and keeps building the pattern library of the personalization patterns. In some embodiments, a layout associated with a generated personalized photobook may be adaptable to highlight the personalization that have been performed in the generated personalized photobook and may be flexible to differ from one photobook to the other while maintaining thematic similarity across multi-level and multiple teams.

In addition to the system and the method for generating personalized photobooks, with varying degrees of personalization, for different entities at the different levels of granularity, the invention discussed herein provides additional methods for scalable review to increase overall desirability and feasibility of producing multi-level personalized photobooks. The methods for intelligent ordering may further aid the photobook organizations in providing dynamic/unique pricings and recommendations based on a degree of personalization performed without any human intervention.

The invention further includes methods and system that allow marking up the dynamic template with objects that can be replaced and finding suitable candidates as replacement or to be filled-in using the personalization patterns that are being learnt based on user activity and content characteristics, while also allowing marking objects that need to be retained in the derived photobooks at subsequent granularities. This would allow a user to better achieve thematic coherence between multiple personalized photobooks generated at same or different levels of granularity.

The invention discussed herein is advantageous in a number of respects. For instance, the system and the methods discussed herein enable the creation of personalized photobooks at different levels of granularities of an entity (e.g., school) going from abstract to specific, including but not limited to (a) no personalization (e.g., one photobook per school) (b) group-level personalization (e.g., one photobook per grade or class or siblings or family), (c) full personalization (e.g., one photobook per individual or child). Furthermore, with dynamic templates, this invention accommodates for the breadth of the entity's content corpus to determine the amount of coverage and comprehensiveness of each event for that entity which might be different from that of another entity at the same level of granularity or at a different level of granularity. Lastly, depending on the degree of personalization (e.g., level and/or extent of personalization), a dynamic pricing and recommendation may be associated for intelligent ordering for photobooks for multiple entities with varying degrees of personalization at different levels of granularity.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A-1C illustrates a flowchart of an example method for generating personalized photobooks, with varying degrees of personalization, for different entities at different levels of granularity, in accordance with particular embodiments.

FIG. 2 illustrates a flowchart of an example method for learning personalization patterns based on content characteristics and user activity, in accordance with particular embodiments.

FIG. 3 illustrates a flowchart of an example method for generating unique pricing for multiple personalized photobooks at different levels of granularity based on degrees of personalization, in accordance with particular embodiments.

FIG. 4 illustrates a flowchart of an example method for recommending a degree of personalization for a photobook based on content associated with the photobook and then generating the photobook based on recommended degree of personalization, in accordance with particular embodiments.

FIG. 5 illustrates a high-level overview of dynamic template(s) generated for each level of granularity and example photobooks generated at each level using the dynamic template(s) associated with the level.

FIG. 6 illustrates an example graphical user interface for scalable review of example photobooks generated for entities at different levels of granularity.

FIGS. 7A-7D illustrates example graphical user interfaces for reviewing and modifying example personalized photobooks generated for different entities at different levels of granularity.

FIG. 8 illustrates an example graphical user interface depicting a marked up photobook for easy review and editing of the photobook.

FIG. 9 illustrates an example computer system.

### DETAILED DESCRIPTION OF EXAMPLE EMBODIMENTS

As discussed earlier, prior existing systems and methods do not generate personalized photobooks (e.g., school yearbooks, child yearbooks) at different levels of granularity. Generally, these prior systems and methods use a single base template in order to generate personalized photobooks. Furthermore, existing or prior systems and methods do not provide an intelligent way of reviewing, pricing, and recommending different personalized photobooks suitable for different users. The present disclosure relates to systems and methods for generating, reviewing, and ordering a plurality of personalized photobooks for different entities at different levels of granularity. Although the overview is explained with respect to one of the systems of the present disclosure, the overview is equally applicable to other implementations, without departing from the scope of the present disclosure.

The present disclosure describes aspects relating to generating personalized photobooks for multiple entities with varying degrees of personalization at different levels of granularity, from a content corpus. In one example, the aspects described in the present disclosure facilitate in creating, reviewing, and ordering of personalized photobooks (e.g., yearbooks) that lead to, for example, but not limited to, minimizing creation time, minimizing review time, and error rate which is otherwise a time-consuming and costly process for multiple personalized photobooks. This may further help to improve the overall quality and productivity of photobook deliverables for the photobook industry, leading to better customer satisfaction levels for photobook organizations.

A system and a method implemented by the system discussed herein consider each entity to be a part of multiple and multi-level teams, and photobooks associated with entities associated with these multi-level teams are gradually being personalized to the extent appropriate for them based on the characteristics of their content corpus. In particular embodiments, the photobooks may be iteratively personalized by at least (1) transforming a previous template from which a previous photobook was generated at a previous level of granularity into a dynamic template (e.g., unique or different template at particular level of granularity) entity at current level of granularity and (2) using the transformed template (e.g., dynamic template derived from previous template) to generate a personalized photobook for the entity at the current level of granularity. In some embodiments, in addition to using the dynamic template, the personalized photobook for the entity at the current level of granularity may be generated using a pattern library of personalization patterns, content characteristics associated with the entity, and previous photobook(s) that have been generated. This may help to maintain a thematic similarity (e.g., similar theme, background, design elements, stickers, etc.) across all the personalized photobooks generated at different levels of granularity. The system and the method discussed herein continuously learns personalization patterns based on content characteristics and user activity and keeps building the pattern library of the personalization patterns. In some embodiments, a layout associated with a generated personalized photobook may be adaptable to highlight the personalizations that have been performed in the generated personalized photobook and may be flexible to differ from one photobook to the other while maintaining thematic similarity across multi-level and multiple teams.

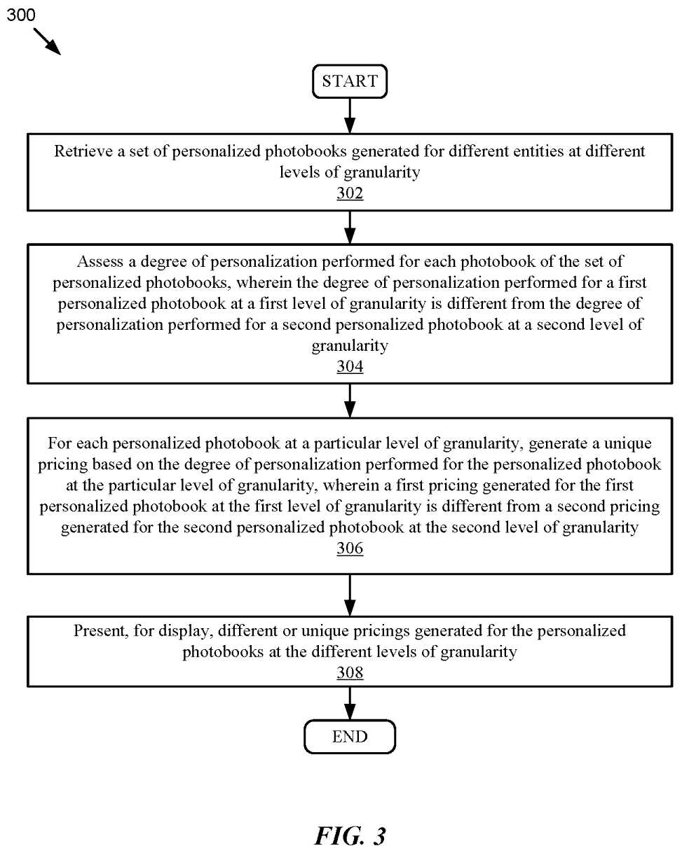

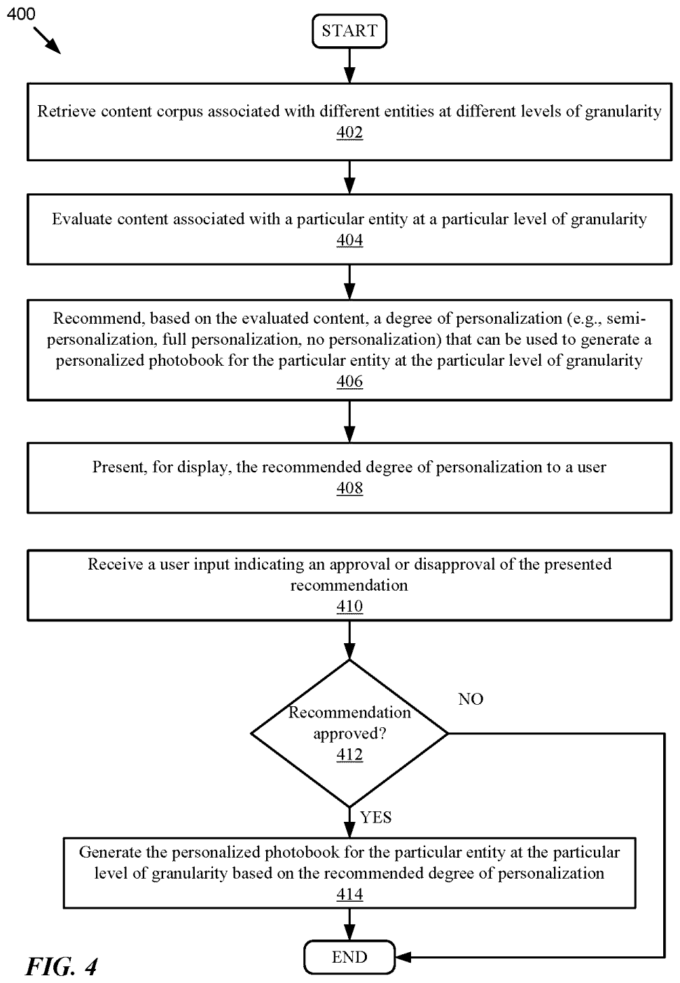

In addition to the system and the method for generating personalized photobooks, with varying degrees of personalization, for different entities at different levels of granularity, the invention discussed herein provides additional methods for scalable review to increase overall desirability and feasibility of producing multi-level personalized photobooks. The methods for intelligent ordering (e.g., as shown for example in FIGS. 3 and 4) may further aid the photobook organizations in providing dynamic/unique pricings and recommendations based on an extent and level of personalization without any human intervention.

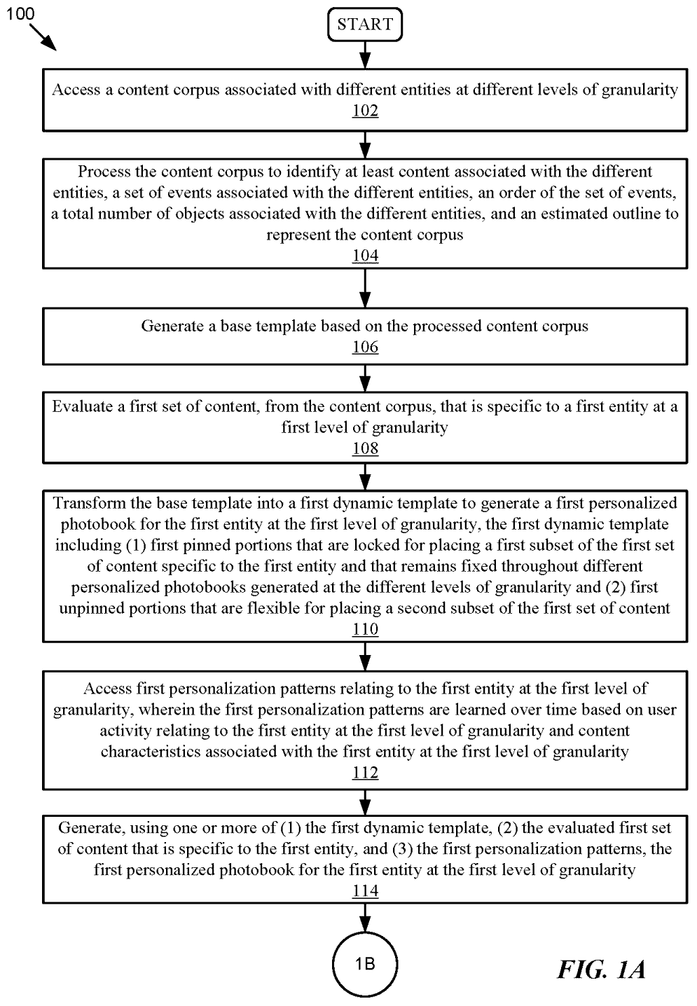

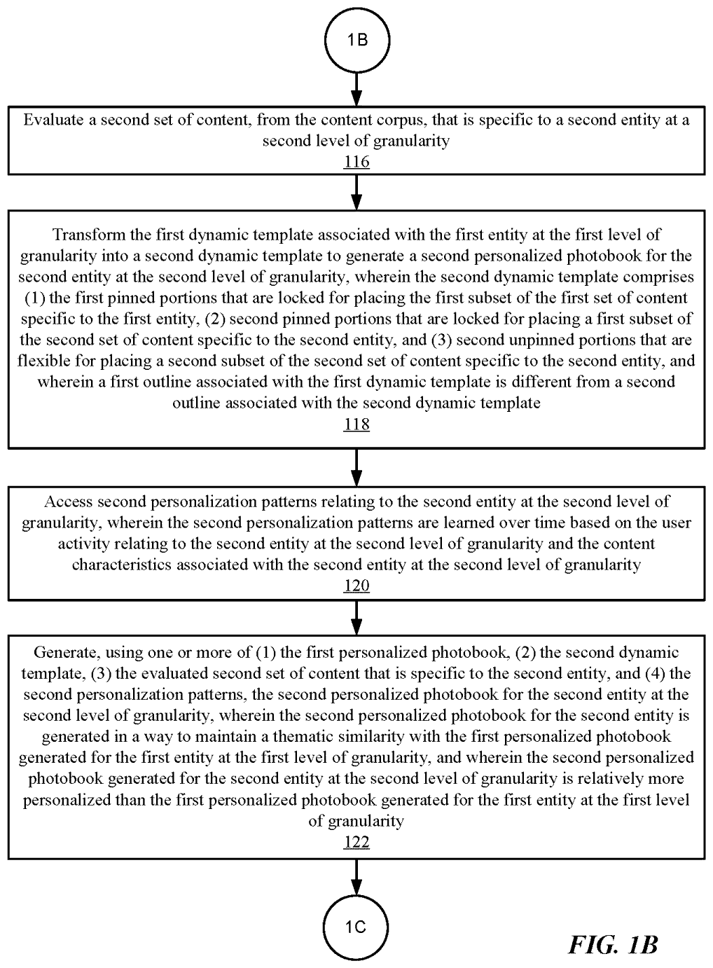

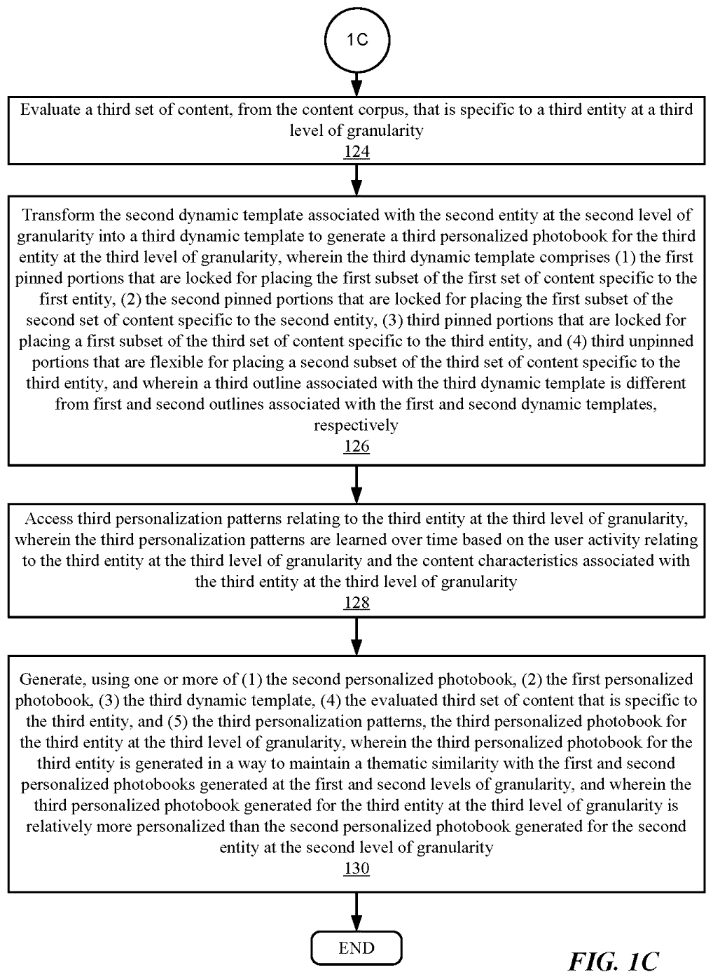

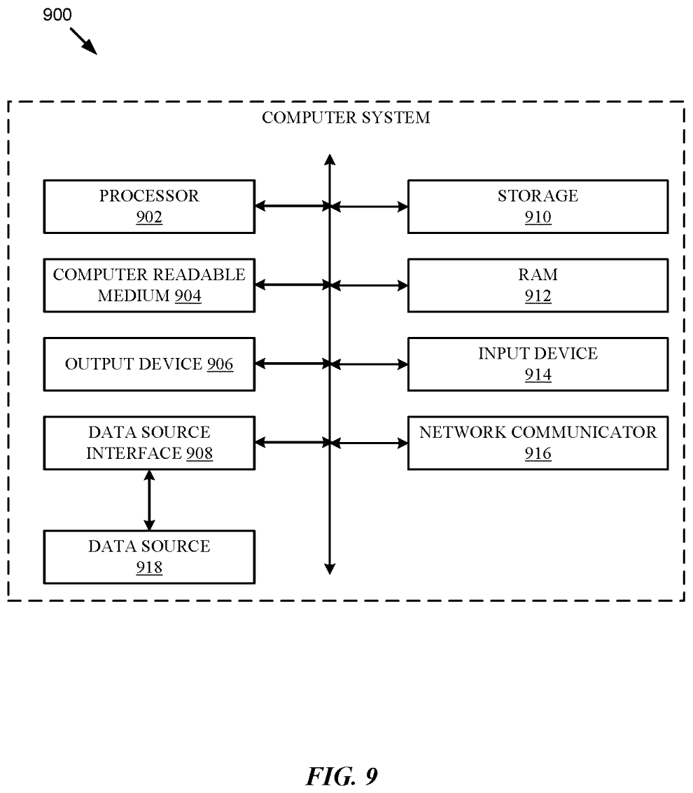

FIGS. 1A-1C illustrates a flowchart of an example method 100 for generating personalized photobooks, with varying degrees of personalization, for different entities at different levels of granularity, in accordance with particular embodiments. Modifications, additions, or omissions may be made to method 100. Method 100 may include more, fewer, or other steps. For example, operations may be performed in parallel or in any suitable order. As another example, the method 100 illustrated in FIGS. 1A-1C represents generation of personalized photobooks at a first level, a second level, and a third level of granularity. However, it should be understood that method 100 is not limited by any way to the first, second and third levels, and any number of levels of personalization is possible and within the scope of the present disclosure. Also, it should be understood that although a single entity is shown and described to be associated at each level of granularity in the method 100, there may be multiple different entities associated at the same level of granularity. Furthermore, an entity at a particular level (e.g., third level of granularity) may be derived from multiple entities at a previous level (e.g., second level of granularity). In particular embodiments, steps 102-130 of the method 100 may be implemented or executed on one or more processors. For example, each of the steps 102-130 may be executed by the processor 902, as shown in FIG. 9.

Referring to FIG. 1A, the method 100 begins, at step 102, where a processor (e.g., processor 902 of computer system 900) accesses a content corpus (interchangeably sometimes also referred to as a knowledge graph) associated with the different entities at the different levels of granularity. As an example and not by way of limitation, the content corpus that is accessed at step 102 may include a plurality of images (e.g., photos), videos, texts, portrait pages, scannable codes (e.g., QR codes), etc. Content associated with the content corpus may be associated with the different entities. As another example and not by way of limitation, the content corpus may include (1) content collected from different sources (e.g., submitted by child parents, teachers of different classrooms, staff, etc.), (2) photos of children of a particular classroom, (3) photos of particular events (e.g., Halloween event, Christmas event, etc.) happened on a class or grade level, (4) photos of events happened on a school-wide level, (5) information associated with the school (e.g., principal's letter, principal photos, school roster), (6) information on various events happened in the school for a particular year (e.g., school calendar, school activities), etc. In particular embodiments, the different entities may include, for example and without limitation, a school at the first level of granularity, a grade at the second level of granularity, a class at the second level of granularity, a club (e.g., soccer club) at the second level of granularity, siblings at the second level of granularity, and individual children of each grade and/or class at the third level of granularity.

The method 100 continues to step 104, where the processor processes the content corpus. In particular embodiments, processing the content corpus may include, for example, identifying content associated with the different entities, a set of events (interchangeably referred to as category, milestone, topic) associated with the different entities, a chronological or other order of the set of events, a total number of objects (e.g., photos, videos, stickers, emoticons, RFIDs, QR codes) associated with the different entities, and an estimated outline to represent the content corpus. An outline may be composed of, but not limited to, different events, order of events, pages per events, objects on pages, etc. In some embodiments, processing the content corpus may include, for example and without limitation, red-eye fixing, resolution detection and fixing, cropping for different aspect ratio, etc.

In other embodiments, the method 100 uses photos uploaded from different sources (e.g., by the parents and families that might be different or additional to the content utilized by the school) to only be used for entities for which it is applicable by incorporating that information as semantics or tags. Instead of this content to only be shown in specific spreads (e.g., specific pages), the content may be distributed across the different events of the photobook by utilizing its semantics and integrating this content in the processed corpus for that entity.

The method 100 continues to step 106, where the processor generates a base template based on the processed content corpus. A template at the highest level (e.g., root node) of granularity is referred to as the base template. The overall workflow or method 100 utilizes the base template to iteratively replace or fill in personalized content at entities belonging to each level of granularity going from abstract (e.g., a team corresponding to the whole school) to less abstract (e.g., a team corresponding to a grade) to lesser abstract (e.g., a team corresponding to a class or club) to specific (e.g., the individual). In some embodiments, the base template may be manually or semi-automatically created by determining an order of events represented as outline in chronological or a pre-defined order, estimating the number of spreads an event should have, composing the photobook with a set of photos presenting relevant coverage of the event, etc. In addition, in some instances, a base template may be marked up manually or automatically to indicate objects and semantics. In particular embodiments, the base template may include a specific number of pages to represent the content corpus, a particular number of slots for inserting content on each page of the template, different design elements (e.g., background, stickers, overall theme) for designing each page, etc.

The method 100 continues to step 108, where the processor (e.g., processor 902 of system 900) evaluates a first set of content, from the content corpus, that is specific to a first entity at a first level of granularity. By way of an example and not limitation, the first entity at the first level of granularity is a school. In particular embodiments, evaluating the first set of content specific to the first entity may include, for example, identifying various objects that are associated with the first entity at the first level, evaluating a quality of each object (e.g., photo quality) associated with the first entity in the content corpus, tags associated with each object of the first entity, ranking each object associated with the first entity at the first level. In some embodiments, the ranking of objects is performed by a ranking algorithm. The ranking algorithm may be a machine-learning (ML) model, which may be trained to evaluate the objects and rank them based on different criteria, such as, facial recognition, tags, quality, aspect ratio, similarity between different objects, etc. Each entity type (e.g., school, grade, class, siblings, child etc.) may be backed by machine-learning models that may be trained for different levels of granularity based on different criteria. Stated differently, there may be ML model corresponding to each level of the different levels of granularity. For example, a machine-learning model corresponding to a first level of granularity (e.g., at school-wide level) would pick photos that represent the larger groups and events, like class pictures or annual/monthly school-wide events. As another example, a machine-learning model corresponding to a second level of granularity (e.g., class-level or grade-level) would mostly include photos that are representative of a small group of classroom students and may or may not include photos of students of other teams.

In certain embodiments, evaluating the content (e.g., evaluating content at step 108 or 116 or 124) may include additional preprocessing, which may be done to create data structures used to rank and/or order objects (e.g., photos) based on context, such as, events at different levels of granularity. In some embodiments, ranking the different objects in the content may be based on tags or attribute identifiers associated with these objects. For example, special tags can be given to indicate photos that are important and associate additional semantics, such as, a photo of a child with her teacher, portrait photos, etc. In some embodiments, the tags or attribute identifiers may be identified based on performing facial recognition using facial recognition models.

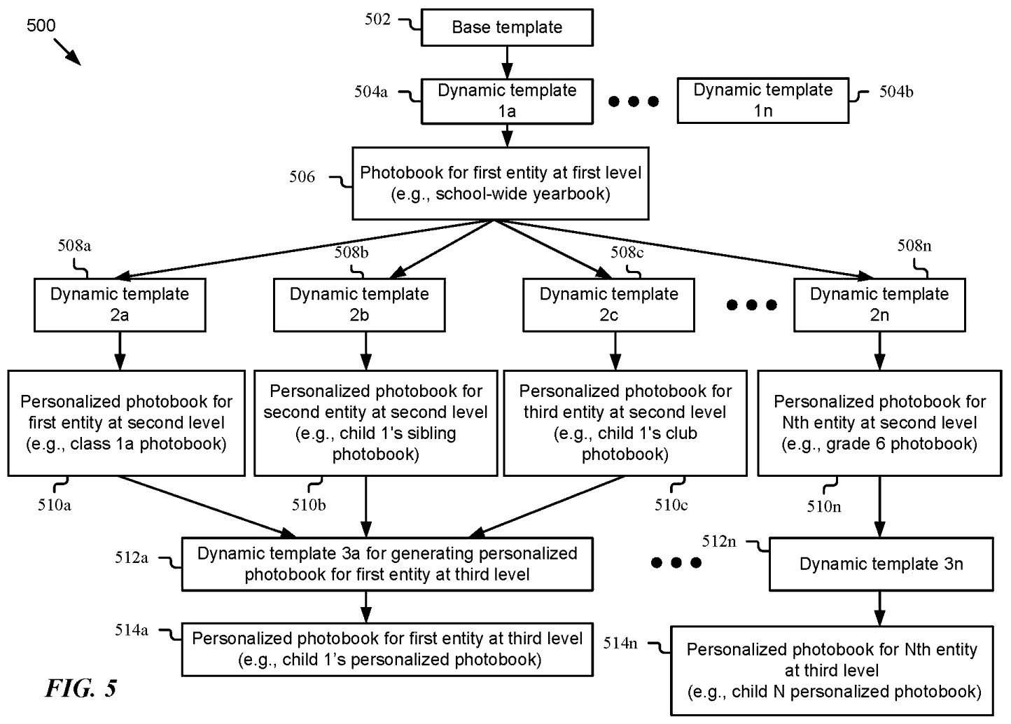

The method 100 continues to step 110, where the processor (e.g., processor 902 of system 900) transforms the base template into a first dynamic template to generate a first personalized photobook for the first entity at the first level of granularity. In particular embodiments, the first dynamic template may include, for example and without limitation, (1) first pinned portions that are locked for placing a first subset of the first set of content specific to the first entity and that remains fixed throughout different personalized photobooks generated at the different levels of granularity and (2) first unpinned portions that are flexible for placing a second subset of the first set of content. In one embodiment, the first dynamic template at the first level of granularity, obtained after the transformation of step 110, may be the same or similar to the base template. However, it should be noted that this may not be the case at dynamic templates generated at subsequent levels of granularity. In some embodiments, instead of a single dynamic template at a particular level of granularity, two or more dynamic templates may be generated at the particular level, as shown for example in FIG. 5, which is discussed later below. In other embodiments, a dynamic template that is generated for a photobook at a particular level may be based on each event/page under consideration, specificity of objects (e.g., photos) and pages for each event since a certain set of objects are applicable to the whole school, some are applicable to the grade level such as class trips school and so on. In other embodiments, certain pages in a dynamic template may have one or more empty slots marked up to introduce personalized content. For example, a cover page may be marked up to show the photo and name of each entity whose yearbook it is for.

In particular embodiments, the system and the method discussed herein automatically marks up some fraction of the slots in a template as pinned. In other embodiments, a user with the right level of access (e.g., an administrator) marks up slots as pinned. In one embodiment, the pinned photos may be identified using ML models, simple heuristics, or human input and may be encoded in the dynamic template of the photobook generated for that entity. In another embodiment, the transformation of the base template into the first dynamic template includes marking all or no slots as pinned. In another embodiment, bulk editing may be achieved by pinning content, layouts, or patterns. A pinned page may lock the page and allow no changes.

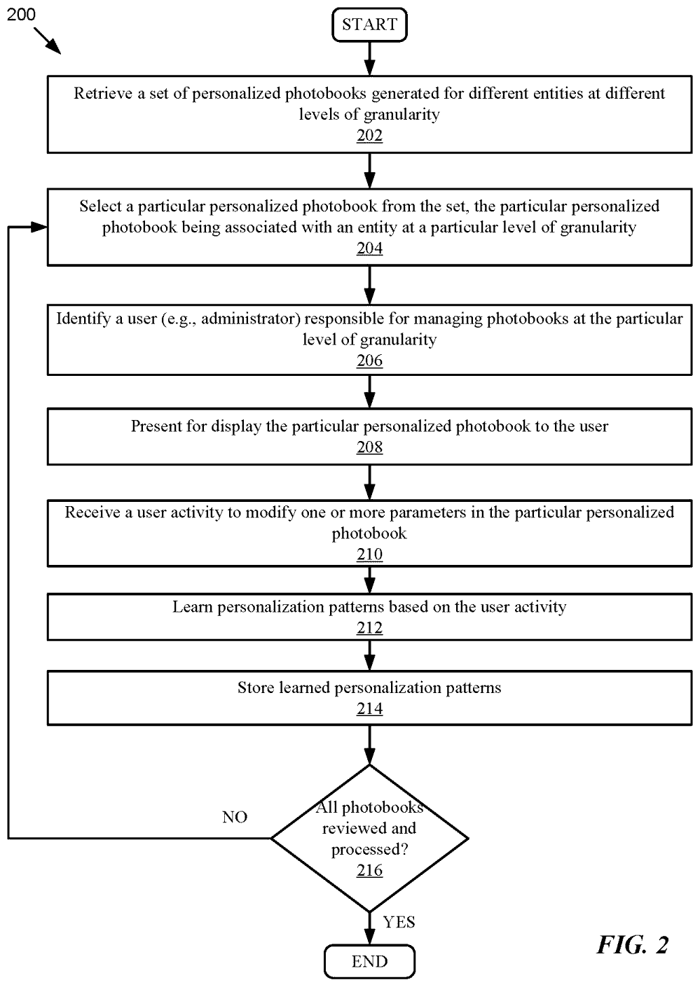

The method then continues to step 112, where the processor accesses first personalization patterns relating to the first entity at the first level of granularity. The first personalization patterns may be learned over time based on user activity relating to the first entity at the first level of granularity and content characteristics associated with the first entity at the first level of granularity. Learning these personalization patterns is further shown and discussed in reference to at least FIG. 2. In some embodiments, personalization patterns indicate composition in the set (i.e., not fixing the position in the layout). For example, layouts across photobooks can be exactly the same or completely different. These include but are not limited to layout enhancements such as, highlighting visual features such as borders/patterns/size of slot for personalized photos or prominent slots, automatic layout adjustment so that highlighted photos take prime spots, etc. In some embodiments, method 100 may include automatically generating pages of the team, such as ‘featuring the child’, ‘featuring the class’, ‘featuring the siblings’ etc.

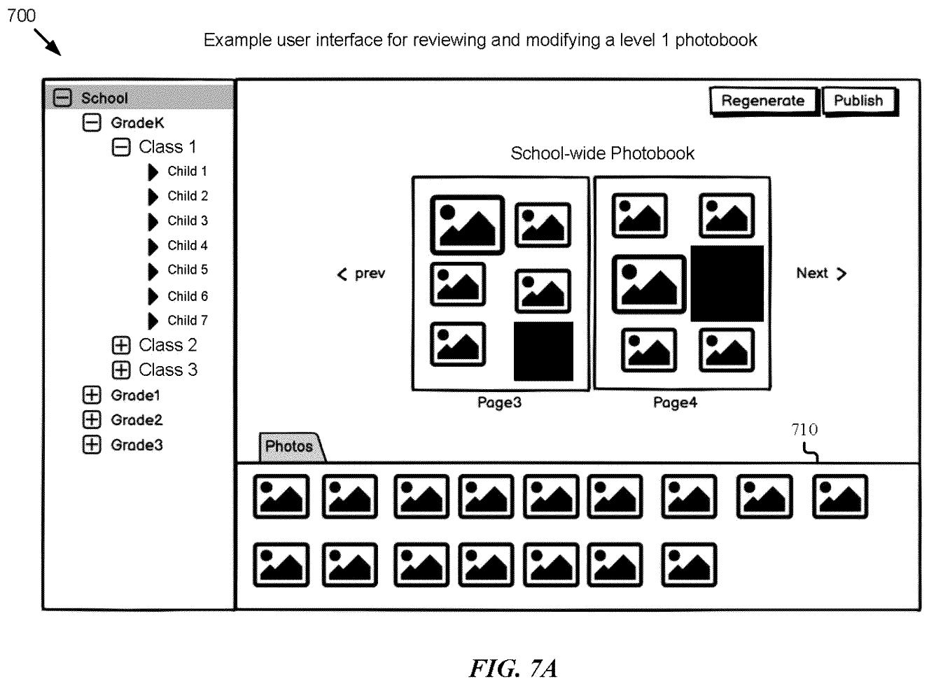

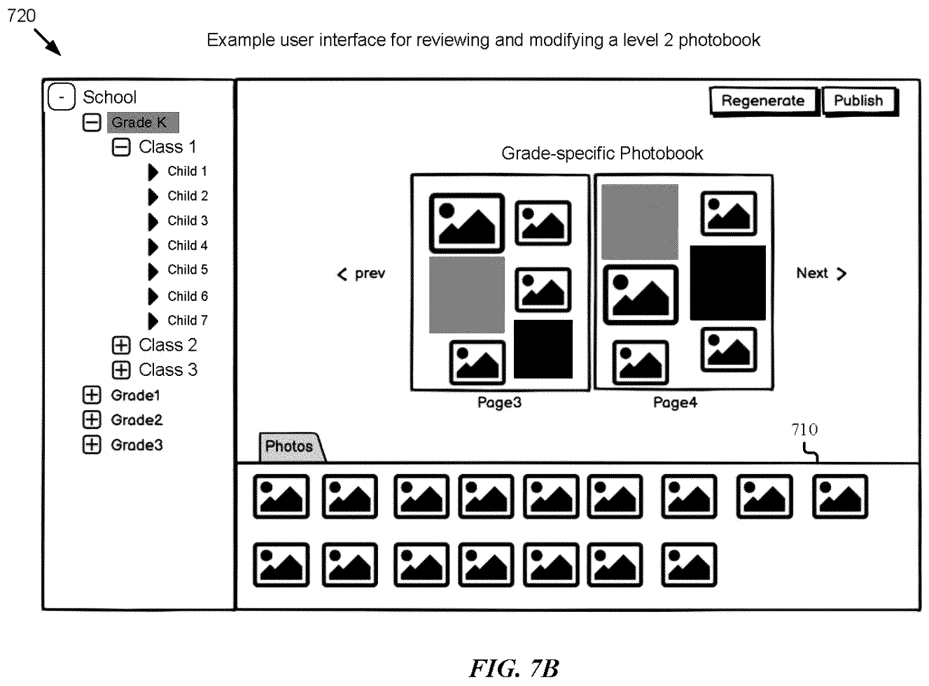

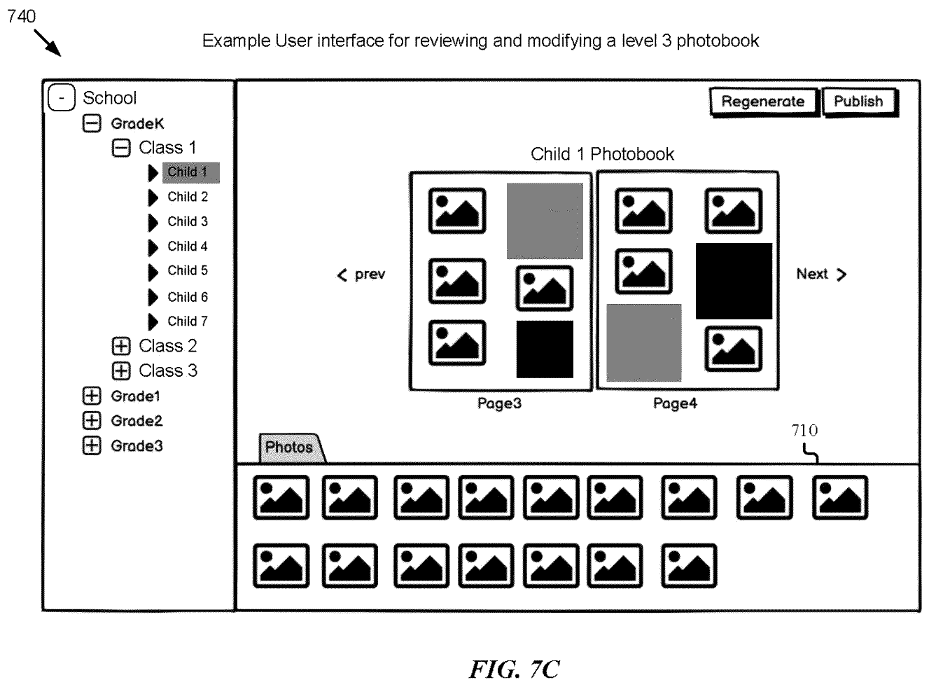

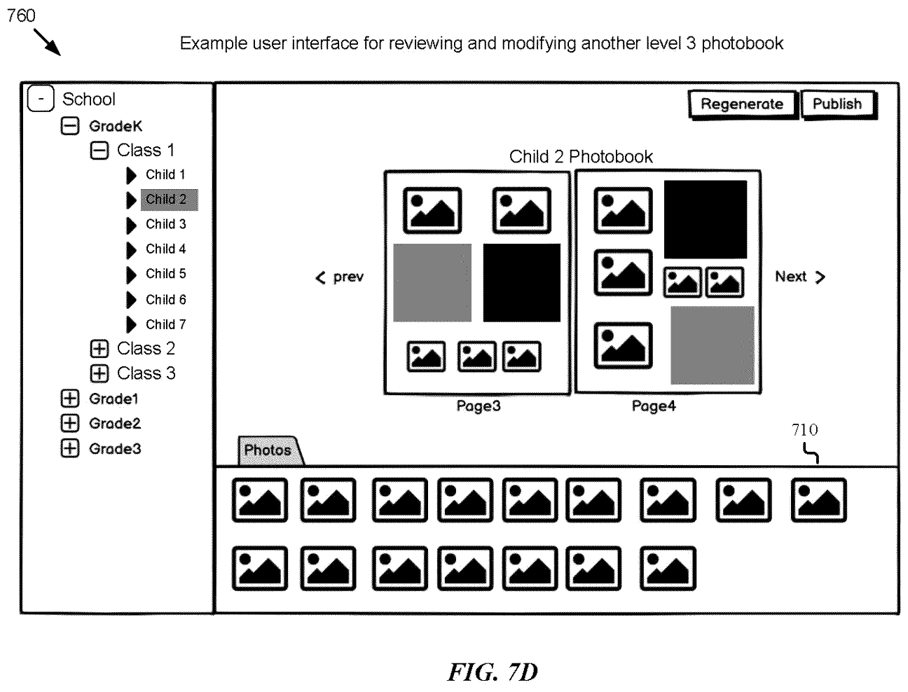

The method 100 continues to step 114, where the processor generates, using one or more of (1) the first dynamic template, (2) the evaluated first set of content that is specific to the first entity, and (3) the first personalization patterns, the first personalized photobook for the first entity at the first level of granularity. FIG. 7A shows an example photobook (e.g., school-wide yearbook) that may be generated at the first level of granularity. In one embodiment, method 100 uses at least the first dynamic template to generate the first personalized photobook for the first entity at the first level of granularity. In another embodiment, the method 100 uses all of (1) the first dynamic template, (2) the evaluated first set of content that is specific to the first entity, and (3) the first personalization patterns in order to generate the first personalized photobook for the first entity at the first level of granularity.

Referring now to FIG. 1B, the method 100 shows steps 116-122 to generate a second personalized photobook for a second entity at a second level of granularity. At step 116, the processor (e.g., processor 902 of system 900) evaluates a second set of content, from the content corpus, that is specific to a second entity at a second level of granularity. Evaluating the second set of content may be performed similar to evaluating the first set of content as discussed above with respect to step 108, and therefore the description of the evaluation performed at step 116 is not repeated here.

Responsive to evaluating the second set of content specific to the second entity at the second level, the method continues to step 118, where the processor transforms the first dynamic template associated with the first entity at the first level of granularity into a second dynamic template to generate a second personalized photobook for the second entity at the second level of granularity. In particular embodiments, the second dynamic template associated with the second level of granularity is different from the first dynamic template associated with the first level of granularity. For example, a first outline (e.g., number of pages, layout, aspect ratios, number of slots on each page, etc.) associated with the first dynamic template is different from a second outline associated with the second dynamic template. wherein the second dynamic template. The second dynamic template may include all of the pinned portions from the first dynamic template generated at the first level, but also new pinned portions for locking content specific to the second entity at the second level. In addition to the pinned portions, the second dynamic template may also include unpinned portions or slots that are flexible for inserting content based on the evaluated second set of content. For instance, the second dynamic template associated with the second level of granularity may include (1) the first pinned portions that are locked for placing the first subset of the first set of content specific to the first entity, (2) second pinned portions that are locked for placing a first subset of the second set of content specific to the second entity, and (3) second unpinned portions that are flexible for placing a second subset of the second set of content specific to the second entity.

The method 100 then continues to step 120, where the processor accesses second personalization patterns relating to the second entity at the second level of granularity. The second personalization patterns may be learned over time based on the user activity relating to the second entity at the second level of granularity and the content characteristics associated with the second entity at the second level of granularity. Accessing the second personalization patterns may be performed similar to accessing the first personalization patterns as discussed above with respect to step 112, and therefore details of step 120 are not repeated here.

The method 100 continues to step 122, where the processor (e.g., processor 902 of system 900) generates, using (1) the first personalized photobook, (2) the second dynamic template, (3) the evaluated second set of content that is specific to the second entity, and (4) the second personalization patterns, the second personalized photobook for the second entity at the second level of granularity. In one embodiment, generating the second personalized photobook at the second level is based on at least using the previously-generated photobook(s) at the previous level (e.g., first level) and the second dynamic template. In another embodiment, generating the personalized photobook is based on using all of the previously-generated photobooks, the second dynamic template, the evaluated second set of content specific to the second entity, and the second personalization patterns. For instance, when generating the second personalized photobook, unpinned portions in the second dynamic template are filled based on the second personalization patterns and the evaluated second set of content.

In particular embodiments, the second personalized photobook for the second entity is generated in a way to maintain a thematic similarity with the first personalized photobook generated for the first entity at the first level of granularity. Since a previously-generated photobook at a previous level of granularity (e.g., first personalized photobook at the first level) is also used an input to generate a subsequent photobook at a subsequent level of granularity (e.g., second personalized photobook at the second level), therefore thematic similarity is maintained across the two photobooks. In particular embodiments, the second personalized photobook generated for the second entity at the second level of granularity is relatively more personalized than the first personalized photobook generated for the first entity at the first level of granularity. For example, the second personalized photobook at the second level may contain relatively more specific objects pertaining to the entity at the second level.

Referring now to FIG. 1C, the method 100 shows steps 124-130 to generate a third personalized photobook for a third entity at a third level of granularity. At step 124, the processor (e.g., processor 902 of system 900) evaluates a third set of content, from the content corpus, that is specific to a third entity at a third level of granularity. Evaluating the third set of content may be performed similar to evaluating the first set of content as discussed above with respect to step 108, and therefore details of evaluation performed at step 116 are not repeated here.

The method then continues to step 126, where the processor (e.g., processor 902 of system 900) transforms the second dynamic template associated with the second entity at the second level of granularity into a third dynamic template to generate a third personalized photobook for the third entity at the third level of granularity. In one embodiment, the transformation, at step 126, uses multiple dynamic templates from the second level to generate the third dynamic template for the third level. For example, a personalized book for a child can be composed by using certain events from the classroom photobook (generated at the second level) and certain events from the soccer club photobook (generated at the second level) and certain events from auto-composing some pages specific to the child. This is further shown and discussed in reference to at least FIG. 5.

In particular embodiments, the third dynamic template may include all of the pinned portions from the previous templates generated at previous levels (e.g., first and second levels), but also new pinned portions for locking content specific to the third entity at the third level. In addition to the pinned portions, the third dynamic template may also include unpinned portions or slots that are flexible for inserting content based on the evaluated third set of content specific to the third entity. For instance, the third dynamic template includes (1) the first pinned portions that are locked for placing the first subset of the first set of content specific to the first entity, (2) the second pinned portions that are locked for placing the first subset of the second set of content specific to the second entity, (3) third unpinned portions that are locked for placing a first subset of the third set of content specific to the third entity, and (4) third unpinned portions that are flexible for placing a second subset of the third set of content specific to the third entity. In particular embodiments, a third outline associated with the third dynamic template is different from the first and second outlines associated with the first and second dynamic templates, respectively.

The method 100 then continues to step 128, where the processor (e.g., processor 902 of system 900) accesses third personalization patterns relating to the third entity at the third level of granularity. The third personalization patterns may be learned over time based on the user activity relating to the third entity at the third level of granularity and the content characteristics associated with the third entity at the third level of granularity. Accessing the third personalization patterns may be performed similar to accessing the first personalization patterns as discussed above with respect to step 112, and therefore details of step 128 is not repeated here.

The method then continues to step 130, where the processor generates, using one or more of (1) the second personalized photobook, (2) the first personalized photobook, (3) the third dynamic template, (4) the evaluated third set of content that is specific to the third entity, and (5) the third personalization patterns, the third personalized photobook for the third entity at the third level of granularity. In one embodiment, generating the third personalized photobook at the third level is based on at least using all the previously-generated photobooks at previous levels (e.g., first and second levels) and the third dynamic template. In another embodiment, generating the personalized photobook is based on using all of the previously-generated photobooks, the third dynamic template, the evaluated third set of content specific to the third entity, and the third personalization patterns. For instance, when generating the third personalized photobook, unpinned portions in the third dynamic template are filled based on the third personalization patterns and the evaluated third set of content. The third personalized photobook for the third entity is generated in a way to maintain a thematic similarity with the first and second personalized photobook generated at the first and second levels of granularity. The third personalized photobook generated for the third entity at the third level of granularity is relatively more personalized than the second personalized photobook generated for the second entity at the second level of granularity. For example, the third personalized photobook at the third level may contain relatively more specific objects pertaining to the entity at the third level.

FIG. 2 illustrates a flowchart of an example method 200 for learning personalization patterns based on content characteristics and user activity, in accordance with particular embodiments. The learned personalization patterns may be used to personalize content in a photobook at a particular level of different levels of granularity. In some embodiments, a personalization pattern may be used to modify a layout of the photobook to enhance the newly inserted or deleted content. In some embodiments, personalization patterns may apply to different slots, objects, pages in a template. In some embodiments, the personalization patterns may be able to make content modifications like cropping the image to match an open slot. In other embodiments, personalization patterns may be used to rate pages as good or bad based on the composition and aesthetics of the page such as best subset of photos, best layout and order, best number of photos, sizing of photos, broad coverage of the event, adequate photos of the personalized individual etc.

Modifications, additions, or omissions may be made to method 200. Method 200 may include more, fewer, or other steps. For example, operations may be performed in parallel or in any suitable order. In particular embodiments, steps 202-216 of the method 200 may be implemented or executed on one or more processors. For example, each of the steps 202-216 may be executed by the processor 902, as shown in FIG. 9.

The method 200 begins, at step 202, where the processor retrieves a set of personalized photobooks generated for different entities at different levels of granularity. As an example, first, second, and third personalized photobooks that are respectively generated at the first, second, and third levels of granularity, as discussed in reference to FIGS. 1A-1C, may be retrieved from a memory, such as storage 910 shown in FIG. 9.

The method 200 then continues to step 204, where the processor selects a particular personalized photobook from the set of personalized photobooks retrieved from the memory. The particular personalized photobook may be associated with an entity at a particular level of granularity. For example, the selected personalized photobook from the set may be associated with a particular child at the third level of granularity.

The method 200 continues to step 206, where the processor identifies a user (e.g., administrator) responsible for managing photobooks at the particular level of granularity. In one embodiment, the selected particular personalized photobook is available for quality control and review by a user based on their level of access control.

The method then continues to step 208, where the processor presents, for display, the particular personalized photobook to the user (e.g., administrator). In some embodiments, only one personalized photobook is presented for display to the user. In some embodiments, all the personalized photobooks at the different levels (e.g., first personalized photobook at first level, second personalized photobook at second level, etc.) are presented for display to the user based on their access. In some embodiments, the relevant content for the entity is available for use in the photobook based on the access controls for the user.

The method 200 then continues to step 210, where the processor receives a user activity to modify one or more parameters (e.g., slots, pinned/unpinned portions, layouts, aspect ratio, objects, etc.) in the particular personalized photobook. As an example, the user may be able to upload new objects (e.g., photos) from a particular source (e.g., cloud or local device) and replace existing objects with the newly uploaded objects. As another example, the user may further personalize the photobook using the ranked photos available for that context. Since the photobooks (e.g., yearbooks) are derived iteratively from parent photobooks serving as dynamic templates, users may bulk apply changes to multiple photobooks at once by editing the appropriate entity from which those multiple photobooks are being derived from. This makes reviewing and editing photobooks more efficient. In some embodiments, the user activity may include swapping an unpinned photo in the photobook using the photos available for replacement in the photobook or using the set of relevant photos for the entity. In another embodiment, the user activity may include the user applying a pre-coded personalization pattern to the photobook. In some embodiments, only the personalization patterns applicable to the entity and available to the user (e.g., based on their access controls) are available for use. In some embodiments, the user activity received on the selected particular personalized photobook at a particular level of granularity may be applied to other personalized photobooks at that level and/or subsequent levels.

The method 200 then continues to step 212, where the processor learns personalization patterns based on user activity. In some embodiments, learning the personalization patterns based on the user activity includes training a ML model to automatically personalize content in a photobook. This may include, for example, the ML model automatically selecting content to fill in unpinned portions of a dynamic template associated with the photobook, the ML model automatically identifying which portions to pin and not pin in specific pages of the dynamic template, etc. In particular embodiments, personalization patterns may be pre-coded and available from a library of personalization patterns. For example, a personalization pattern of ‘replace with similar’ replaces template content with similar but more relevant or higher quality content for each applicable (non-pinned) photo/slot. A personalization pattern of ‘insert/swap highly ranked’ inserts or swaps highly ranked content. A personalization pattern of ‘unclutter page’ deletes applicable template content that ranks poorly for the entity in case the page starts getting very cluttered.

In some embodiments, additional patterns may be derived based on content characteristics and/or user activity. For example, if the content corpus showed individuals presenting at a ‘science fair’, for the science spread of Grade 4, it is very likely that those photos do not make it to the science spread in the yearbook of Grade 4. However, in the photobooks of individuals from Grade 4, the system detects content characteristics of a cluster of photos with individuals presenting a poster. It then applies this pattern to all individuals such that each individual's science spread shows them presenting the poster. In some embodiments, the method 200 learns these personalization patterns across datasets and encodes them into its pattern library to apply it when the content characteristics match.

Once the personalization patterns are learned, method 200 continues to step 214, where the processor stores the learned personalization patterns in the memory, such as the storage 910 (e.g., see FIG. 9), for later access and/or retrieval. For instance, the learned personalized patterns associated with a particular level of granularity may be retrieved from the memory when generating a personalized photobook for an entity at the particular level of granularity.

Next, at step 216, the processor makes a determination of whether all the photobooks of the set of personalized photobooks have been reviewed and processed. If the result of the determination is negative, method 200 proceeds back to step 204 to select another personalized photobook from the set at a particular level to process and learn the personalization patterns at that level. If the result of the determination of step 216 is positive, the method 200 ends.

FIG. 3 illustrates a flowchart of an example method 300 for generating unique pricing for multiple personalized photobooks at different levels of granularity based on degrees of personalization, in accordance with particular embodiments. Modifications, additions, or omissions may be made to method 300. Method 300 may include more, fewer, or other steps. For example, operations may be performed in parallel or in any suitable order. In particular embodiments, steps 302-308 of the method 300 may be implemented or executed on one or more processors. For example, each of the steps 302-308 may be executed by the processor 902, as shown in FIG. 9.

The method 300 begins, at step 302, where the processor (e.g., processor 902 of system 900) retrieves a set of personalized photobooks generated for different entities at different levels of granularity. As an example, first, second, and third personalized photobooks that are respectively generated at the first, second, and third levels of granularity, as discussed in reference to FIGS. 1A-1C, may be retrieved from a memory, such as storage 910 shown in FIG. 9.

The method 300 then continues to step 304, where the processor assesses a degree of personalization performed for each photobook of a set of personalized photobooks. In particular embodiments, the degree of personalization may be based on (1) an extent of personalization that has been performed for the photobook and (2) particular level of granularity associated with the photobook. In some embodiments, the extent of personalization may be measured by the number of objects (e.g., photos) replaced in the photobook for that entity. In some embodiments, the extent of personalization may be calculated using the percentage of slots replaced from the total number of available slots for replacement across all the pages of the photobook. In some embodiments, the extent of personalization may be calculated based on a subset of the pages of the photobook.

In particular embodiments, the degree of personalization performed for a first personalized photobook at a first level of granularity is different from the degree of personalization performed for a second personalized photobook at a second level of granularity. By way of an example and without limitation, content present in the second personalized photobook at the second level may be relatively more granular than the content present in the first personalized photobook at the first photobook.

The method 300 then continues to step 306, where for each personalized photobook at a particular level of granularity, the processor generates a unique pricing based on the degree of personalization performed for the personalized photobook at the particular level of granularity. In some embodiments, the degree of personalization is tiered to custom pricing structure for non-personalized, semi-personalized, or fully personalized photobooks.

In particular embodiments, a first pricing generated for the first personalized photobook at the first level of granularity is different from a second pricing generated for the second personalized photobook at the second level of granularity. For example, the system discussed herein may generate a price of $20 for a first photobook (e.g., a school-wide yearbook) at the first level of granularity, whereas a price of $30 for a second photobook (e.g., a class-specific photobook) at the second level of granularity. The difference in pricing is because of the fact that the two books are generated with varying degrees of personalization. As another example, the system discussed herein may generate a price of $20 for a first photobook (e.g., a school-wide yearbook) at the first level of granularity, whereas a price of $35 for a second photobook (e.g., a class-specific photobook) at the second level of granularity. The difference in pricing is because of the fact that the two books are generated with varying degrees of personalization. Stated differently, since the second photobook (e.g., class-specific photobook) is more personalized and granular than the first photobook (e.g., school-wide photobook), the second photobook is priced higher than the first photobook. In some embodiments, the more specific the granularity (e.g., deeper level of granularity or abstraction), the higher the pricing. In some embodiments, the more photos replaced or filled in for personalization, the higher the pricing.

The method 300 then continues to step 308, where the processor presents, for display to one or more users (e.g., users managing or responsible for handling different levels), different or unique pricing generated for the personalized photobooks at the different levels of granularity. In some embodiments, the unique pricing and the degree of personalization associated with the unique pricing are shown to the one or more users only for informative purposes. Based on the display, the one or more users may either confirm the pricing or change the pricing, and the system discussed herein may learn to adapt and better generate pricing for photobook(s) in subsequent iterations.

FIG. 4 illustrates a flowchart of an example method 400 for recommending a degree of personalization for a photobook based on content associated with the photobook and then generating the photobook based on the recommended degree of personalization. Modifications, additions, or omissions may be made to method 400. Method 400 may include more, fewer, or other steps. For example, operations may be performed in parallel or in any suitable order. In particular embodiments, steps 402-414 of the method 400 may be implemented or executed on one or more processors. For example, each of the steps 402-414 may be executed by the processor 902, as shown in FIG. 9.

The method 400 begins, at step 402, where the processor retrieves content corpus associated with different entities at different levels of a granularity. As an example, first, second, and third personalized photobooks that are respectively generated at the first, second, and third levels of granularity, as discussed in reference to FIGS. 1A-1C, may be retrieved from a memory, such as storage 910 shown in FIG. 9.

The method 400 then continues to step 404, where the processor evaluates content associated with a particular entity at a particular level of granularity. In particular embodiments, the processor may evaluate the content based on evaluation discussed in reference to steps 108, 116, or 124.

The method 400 then continues to step 406, where the processor recommends, based on the evaluated content, a degree of personalization (e.g., semi-personalization, full personalization, no personalization) that may be used to generate a personalized photobook for the particular entity at the particular level of granularity. In some embodiments, the system includes an intelligent ordering workflow, which associates a degree of personalization with each photobook and utilizes that for dynamic pricing. For example, depending on the coverage of each child in the content corpus, the intelligent ordering workflow utilizes a personalized ordering recommendation algorithm that suggests to the user if they should purchase a non-personalized, semi-personalized, or fully personalized photobook. In some embodiments, the recommendation can be made before or after generating the photobook.

The method 400 then continues to step 408, where the processor presents, for display, the recommended degree of personalization to a user. Responsive to presenting the recommended degree of personalization to the user, the method 400 proceeds to step 410, where the processor receives a user input indicating approval or disapproval of the presented recommendation. In some embodiments, the user approval is optional and not needed by the system to generate the photobook.

The method 400 then continues to step 412-414, where the processor captures the user's approval of the recommended degree of personalization and generates the personalized photobook for the particular entity at the particular level of granularity based on the recommended degree of personalization. In some embodiments, the personalized photobook is generated irrespective of explicitly receiving the user's approval. Responsive to generating the personalized photobook, the method 400 ends.

FIG. 5 illustrates a high-level overview of 500 dynamic template(s) generated for each level of granularity and example photobooks generated at each level using the dynamic template(s) associated with the level. It is assumed that the content corpus discussed herein has inherent granularities in it. For example, certain events are applicable to all the individuals in the school, while grade and class level events are applicable to sub-sets of all the individuals in the school. Therefore, certain pages in the base template may be composed of school-wide events and certain pages might be composed by utilizing relevant photos from grade-wide events. In addition to the hierarchical school->grade->class->child levels, there is multiple inheritance amongst the teams such as a club or sports team where certain content corpus is only applicable to participants of that club/team who are distributed across grades/classes who are also members of the base level school team.

Each page in the photobook may be derived from one or more templates that may or may not be similar to the templates of the other pages depending on the teams that have content for those events/pages. Each entity, be it a team or an individual may derive its template attributes from the templates of multi-level teams for a page. For example, for an event Halloween, an individual child say child1's spread may be derived from the Halloween spread of his class, which was in turn derived from the spread of his grade and school. In addition to that, certain pages for the photobook of each entity, may derive its template attributes from the templates of multiple teams such as for an event ‘Soccer’ that might not be represented in the school level yearbook and only be created for the ‘Soccer’ team members and if child1's is a part of that team, his photobook will show those spreads. A child switching classrooms mid-way through the year is another use-case that may derive different pages from different photobooks at the previous level.

In some embodiments the entity may be a team or a part of multiple, often multi-level teams. Let's say the entity is an individual who might be a part of a soccer team or a sibling team in addition to the hierarchical (multi-level) teams of their class->grade->school. Each photobook being personalized optimizes its personalization based on the teams it is derived from. Each photobook may have the same or different number of personalized pages and each page may be derived from the same or different teams.

Referring to FIG. 5, one or more first dynamic templates 1a-1n (represented by reference numerals 504a-504n) may be derived from a base template 502 using the process discussed in method 100. Each of the first dynamic templates 1a-1n may be used to generate a photobook at a first level of granularity. For instance, the dynamic template 1a (represented by reference numeral 504a) is used to generate a photobook 506 for a first entity at the first level, such as a school-wide yearbook. Then using the photobook 506 generated at the first level, a plurality of second dynamic templates 2a, 2b, 2c, . . . , 2n (represented by reference numerals 508a, 508b, 508c, . . . , 508n) may be derived from the photobook 506, using the process discussed in method 100. Each of the first second templates 2a-2n may be used to generate a personalized photobook for different entities at the second level of granularity, where a personalized photobook generated for a first entity at the second level may be different from a personalized photobook generated for a second entity at the second level. Stated differently, photobooks generated even at the same level of granularity may be different for each entity associated with that level. For instance, using the dynamic template 2a (represented by reference numeral 508a), personalized photobook 510a is generated for the first entity at the second level (e.g., class 1a photobook), using the dynamic template 2b (represented by reference numeral 508b), personalized photobook 510b is generated for the second entity at the second level (e.g., child 1's sibling photobook), using the dynamic template 2c (represented by reference numeral 508c), personalized photobook 510c is generated for a third entity at the second level (e.g., child 1's club photobook), and using the dynamic template 2n (represented by reference numeral 508n), personalized photobook 510n is generated for a fourth entity at the second level (e.g., grade 6 photobook).

Then using one or more personalized photobooks generated for one or more entities at the second level of granularity, a third dynamic template may be generated for generating a personalized photobook for an entity at the third level. For instance, using the personalized photobooks 510a, 510b, and 510c, a third dynamic template 3a (represented by reference numeral 512a) is generated. Similarly, using the personalized photobook 510n, a third dynamic template 3n (represented by reference numeral 512n) is generated. The third dynamic templates may then be used to generate personalized photobooks for entities at the third level. For example, the dynamic template 3a (represented by reference numeral 512a) is used to generate a personalized photobook 514a for the first entity at the third level, such as child 1's personalized photobook. Similarly, the dynamic template 3n (represented by reference numeral 512n) is used to generate a personalized photobook 514n for Nth entity at the third level, such as child N's personalized photobook.

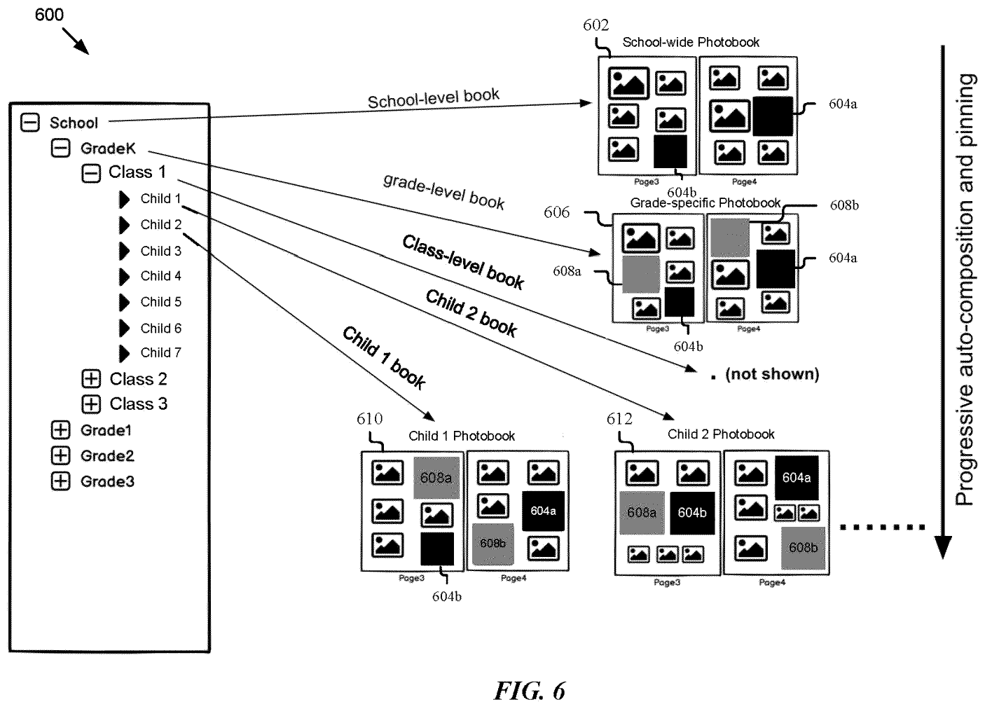

FIG. 6 illustrates an example graphical user interface 600 for scalable review of example photobooks generated for entities at different levels of granularity. The review may include pinned and unpinned portions of each photobook at the different levels of granularity. For instance, the graphical user interface 600 shows a school-wide photobook 602 generated at the first level of granularity. The photobook 602 at the first level includes pinned portions 604a and 604b. The graphical user interface 600 further shows a grade-specific photobook 606 generated at the second level of granularity. The photobook 606 at the second level includes the pinned portions 604a and 604b from the photobook 602 at the first level and further includes new pinned portions 608a and 608b for pinning content specific to the grade. As can be seen from the photobook 606, the layout and aspect ratios of slots and objects in the book 606, and even their positions may change from the photobook 602 at the first level. The graphical user interface 600 further shows two child-specific photobooks 610 and 612 generated at the third level of granularity. Each of the photobook 610 and 612 at the third level includes the pinned portions 604a and 604b from the photobook 602 at the first level as well as the pinned portions 608a and 608 from the photobook 606 at the second level. Each of the photobook 610 and 612 at the third level may further include their own pinned portions (not shown) for pinning content specific to entity at the third level. As can be seen from the photobooks 610 and 612, the layout and aspect ratios of slots and objects in each of these books 610 and 612, and even their positions may change from the photobook 606 at the second level and/or the photobook 602 at the first level.

In particular embodiments, dynamic templates at a particular level may include pinning (e.g., identifying and encoding) a subset of content that is static or fixed for all the photobooks for that entity and for all of its children. For example in FIG. 6, for the school-level photobook 602 (e.g., as further shown in FIG. 7A), black boxes 604a and 604b on Page 3 and Page 4 indicate photos that were pinned for the entity (school in this case) at that level. This means that all the books derived from that entity namely grade-level photobook 606 and class-level photobooks 610 and 612 will have those two photos on those pages in their photobooks unless someone changes those photos to be un-pinned in which case they will no longer be locked and required for the photobooks of the derived entities. As shown in FIG. 6, the grade-level photobook 606 (e.g., as further shown in FIG. 7B) shows two grey boxes 608a and 608b for the same pages, indicating additional photos pinned at that level. This means that all the books derived from that entity namely class-level and child-level books will have those two photos on those pages in their photobooks unless someone changes those photos to be un-pinned in which case they will no longer be locked and required for the photobooks of the derived entities. As shown in FIG. 6, the two child-level books 610 and 612 (e.g., as further shown in FIGS. 7C and 7D) have the pinned photos from the school-level book 602 and the pinned photos from the grade-level book 606 but the layout is flexible to showcase photos relevant to the child based on the subset of the content corpus relevant to the child.

Some or all of those photos may be pinned from the highest to the lowest level of granularity which keeps them consistent across all the photobooks for its children level in the hierarchical system and provides a method for progressive auto-composition of photobooks for multiple entities with varying degrees of personalization at different levels of granularity. They may only be unpinned by going back to its level of pinning by users who have access to make edits to that level of granularity. At the lowest level (i.e., the individual's photobook), no photos need to be pinned since it has no further children. In some embodiments, pinning an object applies only to the content and the layout may be modified in the templates derived from the templates at the previous or next levels.

In some embodiments, users may pin a layout, pin a page, and pin a pattern to transfer the same edits to other entities. Pinning a page implies content and layout of that page to be static across all photobooks derived from that entity. Pinning a layout makes the layout of that page static and non-changeable across all photobooks derived from that entity. Pinning a pattern applies the pattern of that page to all photobooks derived from that entity.

FIGS. 7A-7D illustrates example graphical user interfaces 700, 720, 740, and 760 for reviewing and modifying example personalized photobooks generated for different entities at different levels of granularity. A user may use any of these graphical user interfaces 700-760 in order to modify a personalized photobook at a particular level of granularity. For example, the user may use graphical user interface 700 to modify objects (e.g., photos) in the school-wide yearbook. Similarly, the user may use the graphical user interface 740 to modify objects (e.g., photos) in the child 1's yearbook. By way of an example, the user may drag and drop photos from section 710 in order to modify (e.g., replace) photos in any of the personalized photobooks depicted in FIGS. 7A-7D.

Referring to FIG. 7A, the graphical user interface 700 includes, among other things, an image showing an example school-level yearbook (e.g., photobook 602). Referring to FIG. 7B, the graphical user interface 720 includes, among other things, an image showing an example grade-level yearbook (e.g., photobook 606). Referring to FIG. 7C, the graphical user interface 740 includes, among other things, an image showing an example child-level yearbook (e.g., photobook 610) of a first child. Referring to FIG. 7D, the graphical user interface 760 includes, among other things, an image showing another example of a child-level yearbook (e.g., photobook 612) of a second child. The pinned photos in the school-level yearbook (e.g., shown in the graphical user interface 700 of FIG. 7A) are shown by black boxes. The pinned photos in the grade-level yearbook (e.g., shown in the graphical user interface 720 of FIG. 7B) are shown by gray boxes. In one embodiment, the child-level photobook for child 1 (as shown in FIG. 7C) and the child-level photobook for child 2 (as shown in FIG. 7D) have the same pinned photos from the school-wide and grade-wide yearbook, but they have a different layout and different number of slots for the user to put content specific and relevant to each child whose personalized photobook it is.

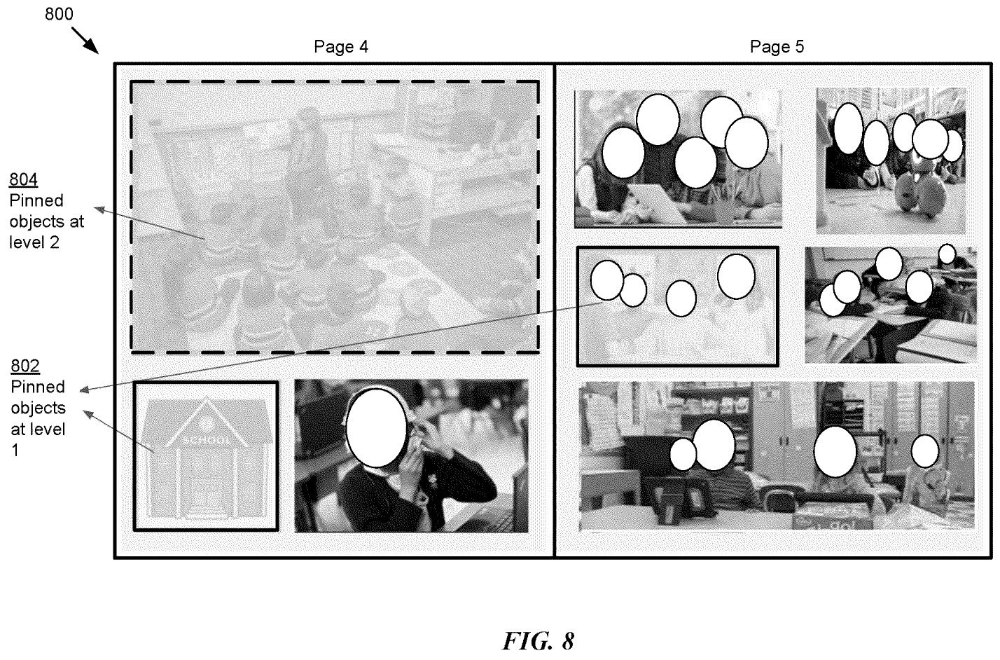

FIG. 8 illustrates an example graphical user interface 800 depicting a marked up photobook for easy review and editing of the photobook, in accordance with particular embodiments. For example, a user with the right level of access may further personalize and perform a quality check on the personalized photobook for an entity at any level of granularity. For each entity, the pinned photos that are inherited for it are grayed out as unchangeable since they can only be changed at the level they were pinned at. All other content or layout can be edited by pinning/unpinning, inserting ranked ordered photos, or deleting non-relevant content. As discussed elsewhere herein, layouts may be changed, content may be swapped, and further enhancements may be made.

In another embodiment, to make it easier to review the plurality of photobooks generated, the system and the methods discussed herein may use annotations and UI features to show the difference (e.g., ‘diff’) in the different granularity levels just like that done in a version control system. The ‘diff’ visualization view of the pages in the photobook highlights the photos and slots that are personalized and changed from one photobook to another. In some embodiments, highlighting in the ‘diff’ visualization may be done by color contrasts, such as graying out unchanged parts of the page or by utilizing borders of the slots and other such visual features. In some embodiments, the pages may be laid out in a multi-page view of the same photobook or in a side-by-side comparison of the same pages in multiple photobooks such that it is easier and faster to spot the difference. In some embodiments, the visualization may show a score of the confidence in the replacements to easily detect which personalization might need a careful manual look and/or needs to be overridden.

In some embodiments, all objects (e.g., pictures, text, etc.) in the user interface 800 are access controlled. For example, only the yearbook coordinator or yearbook team has access to all the levels and photos at those levels to make changes. They can make changes at all levels. The personalized photobooks at the lowest level of granularity (e.g., third level of granularity) may also be edited by representatives for those individuals. They may bring in additional custom photos to be only included in their photobooks. However, they see the pinned photos from the previous levels as annotated (grayed out or marked up) and may not edit (e.g., add, delete, unpin, pin) them. For example, as shown in the graphical user interface 800, reference numeral 802 indicates pinned objects at level 1 of granularity and reference numeral 804 indicates pinned objects at level 2 of granularity.

FIG. 9 illustrates an example computer system 900, according to an example of the present disclosure. In an example embodiment, the computer system 900 may be used to implement the various methods (e.g., methods 100-400) described herein. The computer system 900 may represent a computational platform that includes components that may be in a server or another computer system. The computer system 900 may execute, by a processor (e.g., single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system 900 may include a processor 902 that executes software instructions or code stored on a non-transitory computer-readable storage medium 904 to perform methods of the present disclosure. The software code includes, for example, instructions to perform the steps described with reference to the various methods (e.g., methods 100-400) described herein.

The instructions on the computer-readable storage medium 904 are read and stored in storage 910 or in random access memory (RAM) 912. The storage 910 provides a large space for keeping static data where at least some instructions could be stored for later execution. The stored instructions may be further compiled to generate other representations of the instructions and dynamically stored in the RAM 912. The processor 902 reads instructions from the RAM 912 and performs actions as instructed.

The computer system 900 further includes an output device 906 to provide at least some of the results of the execution as output including, but not limited to, visual information to users. The output device can include a display on computing devices and virtual reality glasses. For example, the display can be a mobile phone screen or a laptop screen. GUIs and/or text are presented as an output on the display screen. The computer system 900 further includes input device 914 to provide a user or another device with mechanisms for entering data and/or otherwise interacting with the computer system 900. The input device may include, for example, a keyboard, a keypad, a mouse, or a touchscreen. In an example, output of any component of the system 900 is displayed on the output device 906. Each of these output devices 906 and input devices 914 could be joined by one or more additional peripherals.

A network communicator 916 may be provided to connect the computer system 900 to a network and in turn to other devices connected to the network including other clients, servers, data stores, and interfaces, for instance. A network communicator 916 may include, for example, a network adapter such as a LAN adapter or a wireless adapter. The computer system 900 includes a data source interface 908 to access data source 918. A data source is an information resource. As an example, a database of exceptions and inferencing rules or plurality of images may be a data source. Moreover, knowledge repositories and curated data may be other examples of data sources.

What has been described and illustrated herein are examples of the present disclosure along with some of its variations. The terms, descriptions and figures used herein are set forth via illustration only and are not meant as limitations. Many variations are possible within the spirit and scope of the subject matter, which is intended to be defined by the following claims and their equivalents in which all terms are meant in their broadest reasonable sense unless otherwise indicated.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. As used herein, the term “includes” means includes but not limited to, the term “including” means including but not limited to. The term “based on” means based at least in part on, the term “based upon” means based at least in part upon, and the term “such as” means such as but not limited to.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A computer-implemented method for generating personalized photobooks for multiple entities with varying degrees of personalization at different levels of granularity, the method comprising:
accessing a content corpus associated with the different entities at the different levels of granularity;
processing the content corpus to identify at least content associated with the different entities, a set of events associated with the different entities, an order of the set of events, a total number of objects associated with the different entities, and an estimated outline for the content corpus;
generating a base template based on the processed content corpus;
evaluating a first set of content, from the content corpus, that is specific to a first entity at a first level of granularity;
transforming the base template into a first dynamic template to generate a first personalized photobook for the first entity at the first level of granularity, wherein the base template is transformed into the first dynamic template based on the evaluated first set of content that is specific to the first entity at the first level of granularity;
generating, using at least the first dynamic template, the first personalized photobook for the first entity at the first level of granularity;
evaluating a second set of content, from the content corpus, that is specific to a second entity at a second level of granularity;
transforming the first dynamic template associated with the first entity at the first level of granularity into a second dynamic template to generate a second personalized photobook for the second entity at the second level of granularity, wherein the first dynamic template is transformed into the second dynamic template based on the evaluated second set of content that is specific to the second entity at the second level of granularity; and
generating, using at least (1) the first personalized photobook generated for the first entity at the first level of granularity and (2) the second dynamic template, the second personalized photobook for the second entity at the second level of granularity, wherein the second personalized photobook for the second entity at the second level of granularity is generated in a way to maintain a thematic similarity with the first personalized photobook generated for the first entity at the first level of granularity.

2. The computer-implemented method of claim 1, wherein the first dynamic template comprises (1) first pinned portions that are locked for placing a first subset of the first set of content specific to the first entity and that remains fixed throughout different personalized photobooks generated at the different levels of granularity, and (2) first unpinned portions that are flexible for placing a second subset of the first set of content.

3. The computer-implemented method of claim 1, further comprising:
accessing first personalization patterns relating to the first entity at the first level of granularity, wherein the first personalization patterns are learned over time based on user activity relating to the first entity at the first level of granularity and content characteristics associated with the first entity at the first level of granularity, and
wherein the first personalized photobook is further generated based on using the first personalization patterns.

4. The computer-implemented method of claim 1, wherein an outline associated with the second dynamic template is different from an outline associated with the first dynamic template.

5. The computer-implemented method of claim 1, wherein the second dynamic template comprises (1) first pinned portions that are locked for placing a first subset of the first set of content specific to the first entity, (2) second pinned portions that are locked for placing a first subset of the second set of content specific to the second entity, and (3) second unpinned portions that are flexible for placing a second subset of the second set of content specific to the second entity.

6. The computer-implemented method of claim 1, further comprising:
accessing second personalization patterns relating to the second entity at the second level of granularity, wherein the second personalization patterns are learned over time based on user activity relating to the second entity at the second level of granularity and content characteristics associated with the second entity at the second level of granularity, and
wherein the second personalized photobook is further generated using the second personalization patterns.

7. The computer-implemented method of claim 1, wherein the thematic similarity is based on using at least one of a similar theme, a design layout, and elements among the first and second personalized photobooks generated for the first and second entities at the first and second levels of granularity.

8. The computer-implemented method of claim 1, wherein the second personalized photobook generated for the second entity at the second level of granularity is relatively more personalized than the first personalized photobook generated for the first entity at the first level of granularity.

9. The computer-implemented method of claim 1, wherein:
the first personalized photobook for the first entity at the first level of granularity is a school-wide yearbook; and
the second personalized photobook for the second entity at the second level of granularity is a class-specific yearbook.

10. The computer-implemented method of claim 1, further comprising:
assessing a degree of personalization performed for each of the first personalized photobook generated for the first entity and the second personalized photobook generated for the second entity;
generating a first pricing for the first personalized photobook and a second pricing for the second personalized photobook based on the degree of personalization assessed for the first personalized photobook and the second personalized photobook, respectively, wherein the second pricing for the second personalized photobook is relatively higher than the first pricing for the first personalized photobook; and
presenting, for display, the first pricing and the second pricing to a user.

11. The computer-implemented method of claim 1, wherein the different entities at the different levels comprise:
a school at the first level of granularity;
different classes and associated grades of the school at the second level of granularity; and
different children of each of the different classes of the school at third level of granularity.

12. The computer-implemented method of claim 1, further comprising:
evaluating a third set of content, from the content corpus, that is specific to a third entity at a third level of granularity;
transforming the second dynamic template associated with the second entity at the second level of granularity into a third dynamic template to generate a third personalized photobook for the third entity at the third level of granularity, wherein the second dynamic template is transformed into the third dynamic template based on the evaluated third set of content that is specific to the third entity at the third level of granularity; and
generating, using (1) the second personalized photobook generated for the second entity at the second level of granularity, and (2) the third dynamic template, the third personalized photobook for the third entity at the third level of granularity, wherein the third personalized photobook for the third entity is generated in a way to maintain the thematic similarity with the first and second personalized photobooks.

13. The computer-implemented method of claim 12, wherein an outline associated with the third dynamic template is different from an outline associated with the second dynamic template.

14. The computer-implemented method of claim 12, wherein the third dynamic template comprises (1) first pinned portions that are locked for placing a first subset of the first set of content specific to the first entity, (2) second pinned portions that are locked for placing the first subset of the second set of content specific to the second entity, (3) third pinned portions that are locked for placing a first subset of the third set of content specific to the third entity, and (4) third unpinned portions that are flexible for placing a second subset of the third set of content specific to the third entity.

15. The computer-implemented method of claim 12, wherein the third personalized photobook generated for the third entity at the third level of granularity is relatively more personalized than the second personalized photobook generated for the second entity at the second level of granularity.

16. The computer-implemented method of claim 12, wherein the third personalized photobook for the third entity at the third level of granularity is a child-specific yearbook.

17. The computer-implemented method of claim 1, further comprising:
generating a third personalized photobook for a third entity at the second level of granularity;
assessing a degree of personalization performed for the second personalized photobook generated for the second entity at the second level of granularity and the third personalized photobook generated for the third entity at the third level of granularity, wherein the degree of personalization performed for the second personalized photobook is different from the degree of personalization performed for the third personalized photobook; and
generating a first pricing for the second personalized photobook and a second pricing for the third personalized photobook, wherein the second pricing is different from the first pricing.

18. The computer-implemented method of claim 1, further comprising:
presenting, for display, one or more of the first personalized photobook or the second personalized photobook to a user;
receiving a user activity to modify one or more parameters in the one or more of the first personalized photobook or the second personalized photobook; and
learning personalization patterns based on the user activity, wherein the learned personalization patterns are further used to generate the one or more of the first personalized photobook or the second personalized photobook.

19. A non-transitory computer readable medium including machine readable instructions that are executable by a processor to:
access a content corpus associated with different entities at different levels of granularity;
process the content corpus to identify at least content associated with the different entities, a set of events associated with the different entities, an order of the set of events, a total number of objects associated with the different entities, and an estimated outline for the content corpus;
generate a base template based on the processed content corpus;
evaluate a first set of content, from the content corpus, that is specific to a first entity at a first level of granularity;
transform the base template into a first dynamic template to generate a first personalized photobook for the first entity at the first level of granularity, wherein the base template is transformed into the first dynamic template based on the evaluated first set of content that is specific to the first entity at the first level of granularity;
generate, using at least the first dynamic template, the first personalized photobook for the first entity at the first level of granularity;
evaluate a second set of content, from the content corpus, that is specific to a second entity at a second level of granularity;
transform the first dynamic template associated with the first entity at the first level of granularity into a second dynamic template to generate a second personalized photobook for the second entity at the second level of granularity, wherein the first dynamic template is transformed into the second dynamic template based on the evaluated second set of content that is specific to the second entity at the second level of granularity; and
generate, using at least (1) the first personalized photobook generated for the first entity at the first level of granularity and (2) the second dynamic template, the second personalized photobook for the second entity at the second level of granularity, wherein the second personalized photobook for the second entity at the second level of granularity is generated in a way to maintain a thematic similarity with the first personalized photobook generated for the first entity at the first level of granularity.

20. A system comprising:
a processor; and
a memory coupled with the processor, storing instructions, which when executed by the processor, cause the system to:
access a content corpus associated with different entities at different levels of granularity;
process the content corpus to identify at least content associated with the different entities, a set of events associated with the different entities, an order of the set of events, a total number of objects associated with the different entities, and an estimated outline for the content corpus;
generate a base template based on the processed content corpus;
evaluate a first set of content, from the content corpus, that is specific to a first entity at a first level of granularity;
transform the base template into a first dynamic template to generate a first personalized photobook for the first entity at the first level of granularity, wherein the base template is transformed into the first dynamic template based on the evaluated first set of content that is specific to the first entity at the first level of granularity;
generate, using at least the first dynamic template, the first personalized photobook for the first entity at the first level of granularity;
evaluate a second set of content, from the content corpus, that is specific to a second entity at a second level of granularity;
transform the first dynamic template associated with the first entity at the first level of granularity into a second dynamic template to generate a second personalized photobook for the second entity at the second level of granularity, wherein the first dynamic template is transformed into the second dynamic template based on the evaluated second set of content that is specific to the second entity at the second level of granularity; and
generate, using at least (1) the first personalized photobook generated for the first entity at the first level of granularity and (2) the second dynamic template, the second personalized photobook for the second entity at the second level of granularity, wherein the second personalized photobook for the second entity at the second level of granularity is generated in a way to maintain a thematic similarity with the first personalized photobook generated for the first entity at the first level of granularity.
